(19) United States
(12) Patent Application Publication
(10) Pub. No.: US 2013/0243473 A1
(43) Pub. Date: Sep. 19, 2013

(54) CLEANING DEVICE AND IMAGE FORMING APPARATUS USING THE SAME

(71) Applicants: Ayumi NOGUCHI, Kanagawa (JP); Masaaki TAKAHASHI, Kanagawa (JP)

(72) Inventors: Ayumi NOGUCHI, Kanagawa (JP); Masaaki TAKAHASHI, Kanagawa (JP)

(73) Assignee: FUJI XEROX Co., Ltd., Tokyo (JP)

(21) Appl. No.: 13/610,202

(22) Filed: Sep. 11, 2012

(30) Foreign Application Priority Data
Mar. 13, 2012 (JP) 2012-055900

(51) Int. Cl. G03G 15/16; B08B 6/00

(52) U.S. Cl. 399/101; 15/1.51

(57) ABSTRACT

A cleaning device includes a cleaning unit including a shaft portion and contactors, the shaft portion being rotatably provided, the contactors being provided along an outer periphery of the shaft portion so as to contact a member to be cleaned, the contactors being formed of conductive fiber, the cleaning unit cleaning the member to be cleaned by rotating and by electrostatically attracting dirt adhered to the member to be cleaned. The contactors satisfy the following condition: 0<fiber density (kF/inch²)×interference (mm) with respect to the member to be cleaned/fineness (denier)<48.

### CROSS-REFERENCE TO RELATED APPLICATIONS

This application is based on and claims priority under 35 USC 119 from Japanese Patent Application No. 2012-055900 filed Mar. 13, 2012.

### BACKGROUND

(i) Technical Field

The present invention relates to a cleaning device and an image forming apparatus using the same.

(ii) Related Art

In general, in an image forming apparatus, such as an electrophotographic copying machine or a laser beam printer, a toner image (developer image) is formed on the surface of a photoconductor drum (an exemplary image carrier, an exemplary member to be cleaned) in accordance with image data. Then, the toner image is transferred to a recording medium (such as a sheet) using a transfer member (an exemplary transfer unit, an exemplary member to be cleaned), to fix the transferred toner to the recording medium by heating, so that a recorded image is obtained.

The following type of recent full-color copying machines and full-color laser beam printers is also known. That is, in this type, toner images formed on photoconductor drums are first-transferred to an intermediate transfer belt (an exemplary image carrier, an exemplary member to be cleaned) using a first transfer member (an exemplary transfer unit, an exemplary member to be cleaned), and the toner images of four colors, yellow, cyan, magenta, and black, are superimposed upon each other on the intermediate transfer belt. The composite toner image is collectively second-transferred to a recording medium using a second transfer member (an exemplary transfer unit, an exemplary member to be cleaned), to form a full-color recorded image.

Transfer efficiency of a toner image is influenced by variations in the resistance value of the intermediate transfer belt and the resistance value of the recording medium as the surface state of any photoconductor drum, the surface state of the intermediate transfer belt, and the temperature/humidity change. Therefore, it is difficult to always maintain the transfer efficiency of the toner image to 100%. Even after the transfer of the toner image, toner remains and is adhered to the surface of a photoconductor drum and the surface of the intermediate transfer belt, to which surfaces the toner image is transferred.

Therefore, hitherto, cleaning devices are provided at a downstream-side of toner-image transfer portions for the photoconductor drums, the transfer member, the first transfer member, the second transfer member, and the intermediate transfer belt. Prior to the formation of the next toner image, residual toner is removed.

A cleaning device having the following structure is known as one cleaning device of this type. In this structure, a cleaning brush having the form of a roller and having conductive fibers implanted therein is brought into contact with a member to be cleaned (such as, the second transfer member), and a potential difference (bias voltage) that is in accordance with a charging polarity of toner is applied between the cleaning brush and the member to be cleaned, so that residual toner and other residual particles are electrostatically attracted to the cleaning brush from the member to be cleaned.

In the cleaning device having such a structure, there is a limit as to the amount of toner that is capable of being carried by the cleaning brush. If the cleaning brush holding a large amount of toner contacts the member to be cleaned, the cleaning performance itself is reduced. Therefore, what is called a detoning mechanism for separating and collecting the toner from the cleaning brush is required. That is, a collecting roller, which is called a detoning roller, is provided within the range of rotation of the cleaning brush, to collect the toner of the member that is cleaned removed by the cleaning brush. Further, the detoning roller is provided with a scraper. The scraper scrapes off the toner collected by the detoning roller, so that the toner is collected in a collecting box using a transporting unit.

In the cleaning device having this structure, by applying bias voltage, attraction force is generated between the member to be cleaned and brush portions (exemplary contactors), themselves, of the cleaning brush. Therefore, a torque that is larger than an ordinary rotating torque is required at a motor (exemplary driving unit) that rotationally drives the cleaning brush and the member to be cleaned. This required torque is increased as the bias voltage is increased.

In order to maintain the cleaning performance, it is necessary to apply the required amount of bias voltage to the brush portions as the member to be cleaned changes with time. If the torque varies in accordance with this, the operation of the motor becomes unstable. Therefore, it becomes necessary to stabilize the torque.

Due to the nature of the motor, as the rotational speed is increased, the upper limit of the torque is reduced. Therefore, when the cleaning brush is highly dependent upon the bias voltage, it is necessary to reduce the torque of the entire cleaning brush. However, if a force at an end is reduced for reducing the torque (that is, if an interference of an end of each brush portion with respect to the member to be cleaned is reduced), the cleaning performance is sacrificed.

### SUMMARY

According to an aspect of the invention, there is provided a cleaning device including a cleaning unit including a shaft portion and contactors, the shaft portion being rotatably provided, the contactors being provided along an outer periphery of the shaft portion so as to contact a member to be cleaned, the contactors being formed of conductive fiber, the cleaning unit cleaning the member to be cleaned by rotating and by electrostatically attracting dirt adhered to the member to be cleaned. In the cleaning device, the contactors satisfy the following condition: 0<fiber density (kF/inch²)×interference (mm) with respect to the member to be cleaned/fineness (denier)<48.

### BRIEF DESCRIPTION OF THE DRAWINGS

An exemplary embodiment of the present invention will be described in detail based on the following figures, wherein:

FIG. 1 is a conceptual view of an exemplary image forming apparatus according to an exemplary embodiment of the present invention;

FIG. 2 is a conceptual view of an enlarged principal portion of the image forming apparatus shown in FIG. 1;

FIG. 3 is a conceptual view of an off-line bench used in examining cleaning devices according to the exemplary embodiment of the present invention;

FIG. 4 is a table of patterns of bias voltages that are applied to cleaning brushes and detoning rollers of the cleaning devices according to the exemplary embodiment of the present invention;

FIG. 5 is a table showing the relationship between the rotational frequencies of the cleaning brushes of the cleaning devices according to the exemplary embodiment of the present invention and the bias voltages that are applied to the cleaning brushes of the cleaning devices according to the exemplary embodiment of the present invention;

FIG. 6 is a table showing the results of measurements obtained by examining the cleaning devices according to the exemplary embodiment of the present invention;

FIG. 7 is a graph showing the relationship between the torque difference and the value equal to fiber density (kF/inch²)×interference (mm)/fineness (denier), which are based on the results of measurements obtained in FIG. 6;

FIG. 8 is a graph showing the relationship between the torque ratio and the value equal to fiber density (kF/inch²)×interference (mm)/fineness (denier), which are based on the results of measurements obtained in FIG. 6;

FIG. 9 is a photograph of the behaviors of two types of cleaning brushes;

FIG. 10 shows a device used for photographing the behaviors of the cleaning brushes; and FIG. 11 illustrates linear contact of a brush portion.

### DETAILED DESCRIPTION

An exemplary embodiment of the present invention will hereunder be described in detail on the basis of the drawings. In the drawings for illustrating the exemplary embodiment, in general, corresponding structural elements are given the same reference numerals, and the same descriptions will not be repeated below.

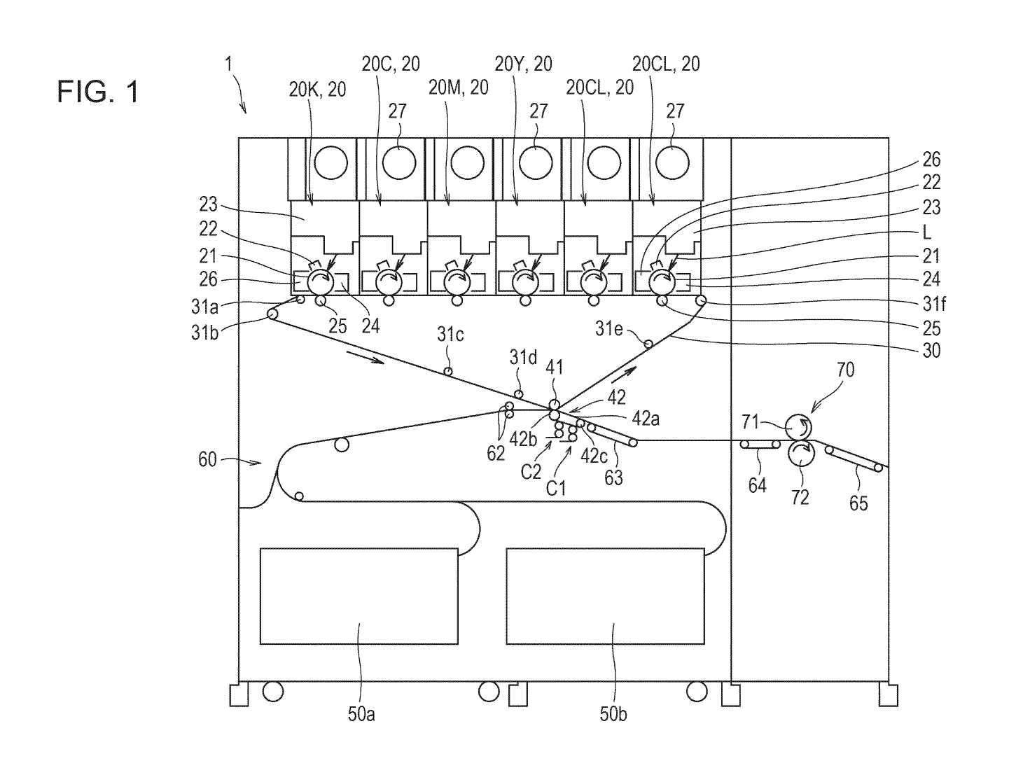

FIG. 1 is a conceptual view of an exemplary image forming apparatus 1 according to an exemplary embodiment of the present invention.

The image forming apparatus 1 according to the exemplary embodiment is, for example, a tandem color printer. The image forming apparatus 1 includes image forming units 20, an intermediate transfer belt (an exemplary image carrier, an exemplary member to be cleaned) 30, a backup roller 41 and a second transfer device (an exemplary transfer unit, an exemplary member to be cleaned) 42 that form a pair, sheet supply trays 50a and 50b, a sheet transporting system 60, and a fixing device 70.

The image forming units 20 include four color image forming units 20Y, 20M, 20C, and 20K, and image forming units 20CL and 20CL for transparent colors. The color image forming units 20Y, 20M, 20C, and 20K form, for example, toner images (exemplary developer images) of four colors, yellow, magenta, cyan, and black. The image forming units 20CL and 20CL transfer, for example, toner images of transparent colors. In order for toner images formed in accordance with pieces of image information of corresponding colors to be first-transferred to the intermediate transfer belt 30, the six image forming units 20CL, 20CL, 20Y, 20M, 20C, and 20K are disposed in accordance with a transparent color, a transparent color, yellow, magenta, cyan, and black in that order along the direction of rotation of the intermediate transfer belt 30. Instead of the image forming units for transparent colors, for example, an image forming unit for a light color, such as light yellow, light magenta, light cyan, or light black, that transfers a toner image of a light color may be provided. Alternatively, an image forming unit 20CL for a transparent color and an image forming unit for a light color may be disposed side by side.

Each image forming unit 20 includes a photoconductor drum (an exemplary image carrier, an exemplary member to be cleaned) 21, a charging device 22, an exposure device 23, a developing device 24, a first transfer roller 25 (an exemplary transfer unit, an exemplary member to be cleaned), and a drum cleaner 26. Each charging device 22 charges the surface of its corresponding photoconductor drum 21 to a specified potential. Each exposure device 23 irradiates the corresponding charged photoconductor drum 21 with laser light L to form an electrostatic latent image. Each developing device 24 develops the electrostatic latent image formed on the corresponding photoconductor drum 21 by the corresponding exposure device 23 to form a toner image. Each first transfer roller 25 transfers the toner image carried on its corresponding photoconductor drum 21 to the intermediate transfer belt 30 at a first transfer section. Each drum cleaner 26 removes residual toner or paper powder from the surface of its corresponding photoconductor drum 21 after the transfer of the toner image. Toner cartridges 27 that supply developer to the developing devices 24 are set at upper sides of the respective image forming units 20.

The first transfer rollers 25 of the corresponding image forming units 20 are disposed so that the first transfer rollers 25 and the corresponding photoconductor drums 21 nip the intermediate transfer belt 30. By applying a transfer bias voltage having a polarity that is opposite to that of a charging polarity of toner (an exemplary developer) to each first transfer roller 25, electric fields are formed between the photoconductor drums 21 and the corresponding first transfer rollers 25. Therefore, the toner images that are charged on the corresponding photoconductor drums 21 are transferred to the intermediate transfer belt 30 by coulomb forces. The photoconductor drums 21 rotate clockwise during the first transfer.

The intermediate transfer belt 30 is a member to which the toner images of the corresponding color components, formed by the corresponding image forming units 20, are successively transferred (first-transferred) for carrying the toner images. The intermediate transfer belt 30 is an endless belt that is placed on supporting rollers 31a to 31f and the backup roller 41. The toner images formed by the corresponding image forming units 20CL, 20CL, 20Y, 20M, 20C, and 20K are first-transferred to the intermediate transfer belt 30 while the intermediate transfer belt 30 rotates counterclockwise in a peripheral direction.

The backup roller 41 and the second transfer device 42 that form a pair constitute a mechanism for forming a full-color image by collectively transferring (second-transferring) the toner images transferred to and superimposed on the intermediate transfer belt 30 to a sheet (an exemplary recording medium), and are disposed so as to oppose each other with the intermediate transfer belt 30 being nipped therebetween. A portion where the backup roller 41 and the second transfer device 42 oppose each other corresponds to a second transfer section.

The backup roller 41 is rotatably set at the inner surface of the intermediate transfer belt 30. The second transfer device 42 is rotatably set while opposing a toner-image transfer surface of the intermediate transfer belt 30. The backup roller 41 and the second transfer device 42 are disposed so that their directions or rotational axes (that is, their directions perpendicular to the plane of FIG. 1) are parallel to each other.

The second transfer device 42 includes a second transfer transport belt 42a disposed at the toner-image transfer surface of the intermediate transfer belt 30. The second transfer transport belt 42a is placed on a drive roller 42b and a driven roller 42c. The drive roller 42b is formed of, for example, a metal (such as SUS) or is a rubber roller that is semiconductive. The drive roller 42b is driven by a motor (an exemplary driving unit) (not shown). The driven roller 42c is, for example, a rubber roller. The second transfer transport belt 42a is an endless annular belt that is formed of conductive resin, such as polyimide, and that is not scratched often. The second transfer transport belt 42a is rotationally driven by the drive roller 42b, and is subjected to tension by the drive roller 42b and the driven roller 42c.

The drive roller 42b is disposed so as to press-contact the backup roller 41 while the second transfer transport belt 42a and the intermediate transfer belt 30 are nipped between the drive roller 42b and the backup roller 41. The drive roller 42b functions as a second transfer roller for second-transferring the toner images to a sheet that is transported along the second transfer transport belt 42a.

The diameter of the driven roller 42c is small so as not to allow the second transfer transport belt 42a to wind thereupon even if, for example, a thin coated sheet is transported.

Cleaning devices (exemplary cleaning devices) C1 and C2 that contact and clean the second transfer device 42 are disposed. The cleaning devices C1 and C2 will be described below.

When transferring the toner images on the intermediate transfer belt 30, a voltage whose polarity is the same as the toner charging polarity is applied to the backup roller 41, or a voltage whose polarity is opposite to the toner charging polarity is applied to the second transfer device 42. This causes a transfer electric field to be formed between the backup roller 41 and the second transfer device 42, so that the toner images carried by the intermediate transfer belt 30 are transferred to a sheet.

For example, sheets of various sizes and thicknesses are held in the sheet supply trays 50a and 50b. The sheets in the sheet supply trays 50a and 50b are drawn out by a pickup roller (not shown) of the sheet transporting system 60. Then, a timing of the sheets is controlled by registration rollers 62 of the sheet transporting system 60, and the sheets are introduced into the second transfer section, so that the toner images are transferred to the sheets. Thereafter, the sheets are transported to the fixing device 70 by transporting belts 63 and 64 of the sheet transporting system 60.

The fixing device 70 fixes unfixed toner images, transferred to, for example, a sheet at the second transfer section, to the sheet by thermocompression. The fixing device 70 includes a heating roller 71, which includes a heater (not shown), and a pressure roller 72, provided so as to oppose the heating roller 71.

After the second transfer, the sheet is transported to a fixing nip where the heating roller 71 and the pressure roller 72 oppose each other, and is discharged while being nipped between the heating roller 71 and the pressure roller 72. At this time, for example, the sheet is heated by the heating roller 71, and is pressed by the pressure roller 72, so that toner images are fixed to, for example, the sheet. For example, the sheet that has passed through the fixing device 70 is sent to a discharge roller (not shown) by a transporting belt 65, and is discharged to the outside of the image forming apparatus 1.

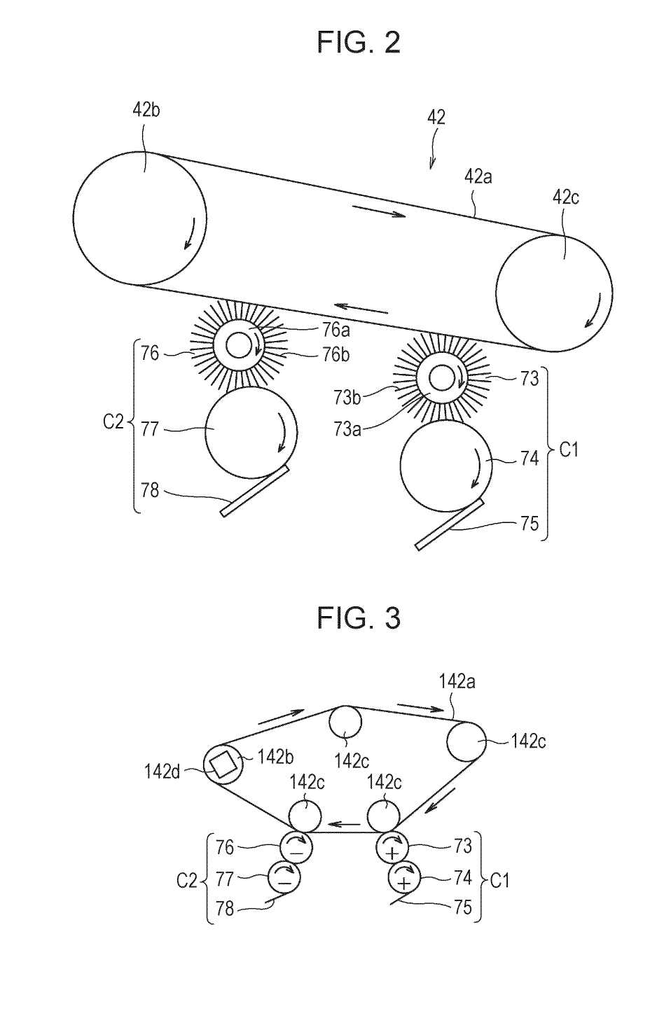

As shown in FIG. 2, in the exemplary embodiment, the cleaning devices serving as exemplary cleaning devices that clean the second transfer transport belt 42a include the first cleaning device C1 and the second cleaning device C2. The first cleaning device C1 includes a conductive cleaning brush (an exemplary cleaning unit) 73 having the form of a roller, and a detoning roller (an exemplary collecting unit) 74. The second cleaning device C2 includes a conductive cleaning brush (an exemplary cleaning unit) 76 having the form of a roller, and a detoning roller (an exemplary collecting unit) 77. Scrapers 75 and 78 are provided at the respective detoning rollers 74 and 77 so as to press-contact the respective detoning rollers 74 and 77.

The conductive cleaning brushes 73 and 76 are disposed in contact with the second transfer transport belt 42a, and remove any dirt, such as toner, adhered to the second transfer transport belt 42a. The detoning rollers 74 and 77 are disposed within the range of rotation of the cleaning brush 73 and the range of rotation of the cleaning brush 76, respectively, and collect the dirt removed by the respective cleaning brushes 73 and 76. The scrapers 75 and 78 scrape off the dirt collected by the respective detoning rollers 74 and 77. The scraped off dirt is collected in a collecting box using a transporting unit (not shown).

As shown in FIG. 2, the cleaning brushes 73 and 76 include respective shafts (exemplary shaft portions) 73a and 76a, which are rotatably provided, and brush portions (exemplary contactors) 73b and 76b, which are provided at outer peripheries of the respective shafts 73a and 76a.

Here, the shafts 73a and 76a are formed of, for example, conductive materials such as metals (aluminum, stainless steel, etc.) or materials in which conductive particles are mixed in resin or synthetic rubber. A motor (an exemplary driving unit) (not shown) rotates the shafts 73a and 76a in a direction of rotation that is the same as a direction of rotation of the drive roller 42b and the driven roller 42c (clockwise in the drawings). The shafts 73a and 76a are electrically connected to a power supply (not shown), and are such that bias voltages are applied thereto.

The brush portions 73b and 76b are formed on the outer peripheral surfaces of the corresponding shafts 73a and 76a by, for example, electrostatic frocking or pile weaving. The brush portions 73b and 76b are formed of, for example, conductive fibers having lengths on the order of from 4.5 to 5.0 mm. The brush portions 73b and 76b are provided so as to extend radially from the outer peripheries of the corresponding shafts 73a and 76b, and contact the second transfer device 42 (more exactly, the second transfer transport belt 42a of the second transfer device 42) serving as a member to be cleaned. The brush portions 73b and 76b are formed by mixing conductive particles (such as carbon black particles) in, for example, nylon, acryl, or polyester.

The cleaning brush 73 including the shaft 73a and the brush portions 73b and the cleaning brush 76 including the shaft 76a and the brush portions 76b rotate around the shaft 73a and the shaft 76a, respectively, so that, in accordance with the procedure that is described later, any dirt adhered to the second transfer device 42 is electrostatically attracted to the brush portions 73b and 76b to clean the second transfer device 42.

The detoning rollers 74 and 77 are each in the form of a pipe in which the outer periphery of a cored bar is covered with resin, such as phenol resin. A motor (an exemplary driving unit) (not shown) rotates the detoning rollers 74 and 77 in a direction of rotation that is the same as a direction of rotation of the shafts 73a and 76a (clockwise in the drawings). The detoning rollers 74 and 77 are also electrically connected to a power supply (not shown), and are such that bias voltages are applied thereto.

Bias voltages having different polarities are applied to the first cleaning device C1, which is positioned at an upstream side in the direction of rotation of the second transfer transport belt 42a, and the second cleaning device C2, which is positioned at a downstream side in the direction of rotation of the second transfer transport belt 42a. That is, since there are variations in the electric charge of toner remaining on the second transfer transport belt 42a after the transfer, a bias voltage having a positive polarity for attracting toner that is negatively charged is applied to the first cleaning device C1, and a bias voltage having a negative polarity for attracting toner that is positively charged is applied to the second cleaning device C2.

In the first cleaning device C1, a positive polarity is applied so that the bias voltage of the cleaning brush 73 and the bias voltage of the detoning roller 74 differ from each other. That is, the bias voltage at the cleaning brush 73 is low, whereas the bias voltage at the detoning roller 74 is high. In the second cleaning device C2, a negative polarity is applied so that the bias voltage of the cleaning brush 76 and the bias voltage of the detoning roller 77 differ from each other. That is, the bias voltage at the cleaning brush 76 is low, whereas the bias voltage at the detoning roller 77 is high. In this way, by causing the bias voltages at the detoning rollers 74 and 77 to be greater than the bias voltages at the cleaning brushes 73 and 76, respectively, the toner collected by the cleaning brushes 73 and 76 is smoothly transferred to the detoning rollers 74 and 77, so that the cleaning performance of the cleaning brushes 73 and 76 is maintained.

As mentioned above, in the cleaning device C1 and the cleaning device C2 having this structure, by applying bias voltages, attraction force is generated between the brush portions 73b of the cleaning brush 73, themselves, and the second transfer transport belt 42a of the second transfer device 42 (serving as a member to be cleaned), and between the brush portions 76b of the cleaning brush 76, themselves, and the second transfer transport belt 42a of the second transfer device 42. Therefore, a torque that is larger than an ordinary rotating torque is required at a motor that rotationally drives the cleaning brushes 73 and 76 and the second transfer transport belt 42a. This required torque is increased as the bias voltages are increased.

In order to maintain the cleaning performance, it is necessary to apply the required amounts of bias voltages to the brush portions 73b and 76b as the second transfer transport belt 42a serving as a member to be cleaned changes with time. If the torque varies in accordance with this, the operation of the motor becomes unstable. Therefore, it becomes necessary to stabilize the torque.

Due to the nature of the motor, as the rotational speed is increased, the upper limit of the torque is reduced. Therefore, when the cleaning brushes 73 and 76 are highly dependent upon the bias voltages, it is necessary to reduce the torques of the entire cleaning brushes 73 and 76. However, if, for reducing the torque, the interference of the end of each of the brush portions 73b and 76b with respect to the second transfer transport belt 42a (a radial length of a portion of each of the rotating cleaning brushes 73b and 76b that interferes with the second transfer transport belt 42a), that is, a force at the end of each of the brush portions 73b and 76b is reduced, the cleaning performance is sacrificed.

Therefore, the present inventors have considered the suppression of variations in the rotating torque of the motor that rotationally drives the cleaning brushes 73 and 76 and the second transfer transport belt 42a without reducing the cleaning performance.

Here, a conceptual view of an offline bench used in considering the suppression of variations in the rotating torque of the motor is shown in FIG. 3.

In FIG. 3, the structure of the first cleaning device C1 and the structure of the second cleaning device C2 are as described above. The structure corresponding to the second transfer device 42 (serving as a member to be cleaned) includes a belt 142a (corresponding to the second transfer transport belt 42a), one drive roller 142b (corresponding to the drive roller 42b) upon which the belt 142a is placed, and driven rollers 142c (corresponding to the driven rollers 42c) upon which the belt 142a is placed. The belt 142a is rotationally driven by the drive roller 142b, and is subjected to tension by the drive roller 142b and the driven rollers 142c. In order to measure the rotating torque at the position of the drive roller 142b, a torque gauge 142d is set at the drive roller 142b.

Similarly to the second transfer device 42, the belt 142a is an endless annular belt that is formed of a conductive resin material, such as polyimide, and that is not scratched often. The drive roller 142b is formed of, for example, a metal (such as SUS) or is a rubber roller that is semiconductive. The driven roller 42c is, for example, a rubber roller.

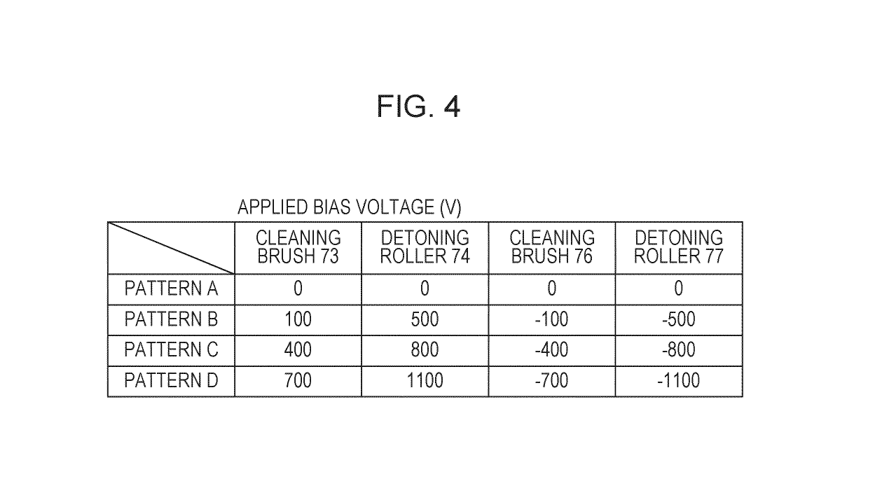

Next, the patterns of bias voltages that are applied to the cleaning brushes 73 and 76 and the detoning rollers 74 and 77 are shown in FIG. 4. As shown in FIG. 4, voltages are applied on the basis of four patterns, patterns A to D.

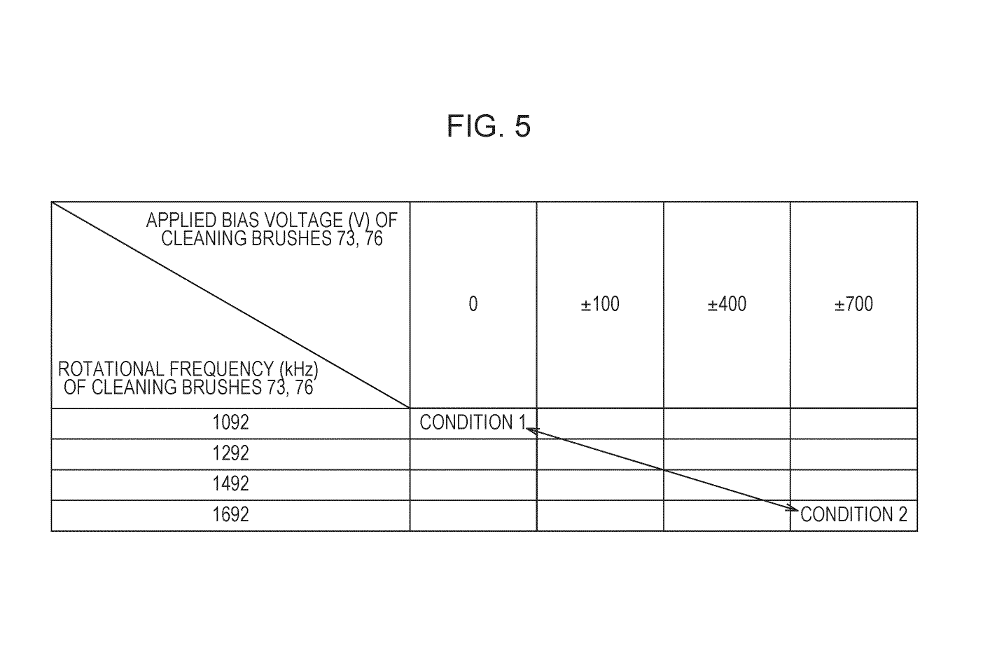

The relationships between the rotational frequencies of the cleaning brushes 73 and 76 and the bias voltages that are applied to the cleaning brushes 73 and 76 are shown in FIG. 5. As shown in FIG. 5, the load is lightest when the rotational frequency is 1092 kHz and the bias voltage is 0 V (Condition 1), and the load is heaviest when the rotational frequency is 1692 kHz and the bias voltage is ±700 V (Condition 2). Therefore, the mode in which variations of the rotating torque of the motor are reduced corresponds to a mode in which variations in the rotating torque in Conditions 1 and 2 are reduced.

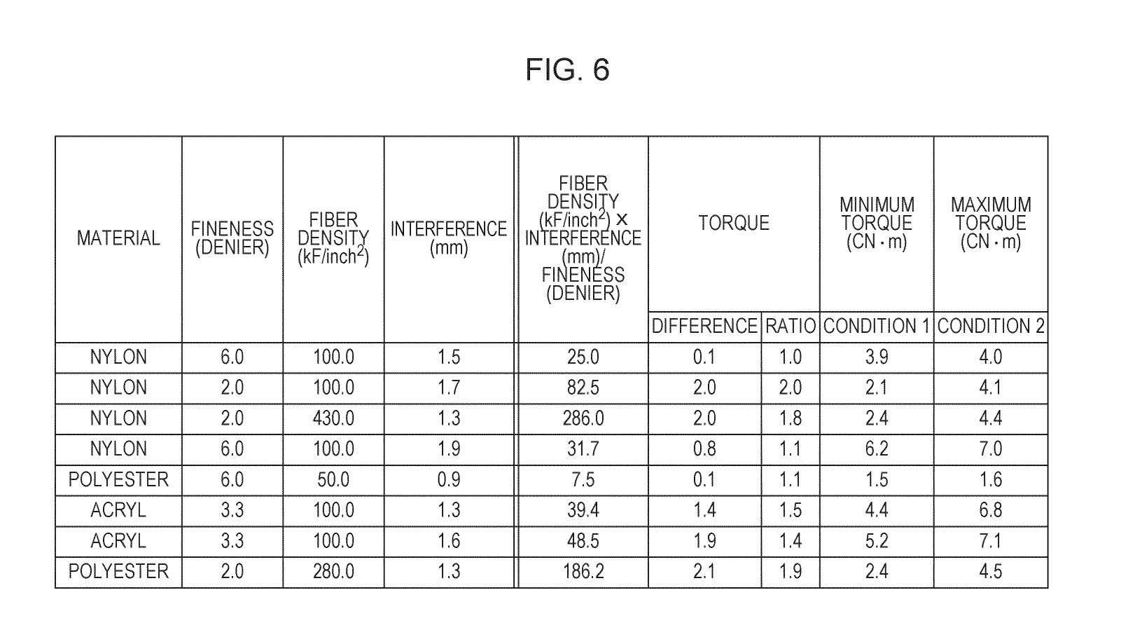

As shown in FIG. 6, measurement results are obtained by setting the materials, the finenesses (denier), the fiber densities (kF/inch²), and the interferences (mm) (that is, the interferences into the belt 142a) of the brush portions 73b and 76b of the corresponding cleaning brushes 73 and 76. The items of the measurement results are:

the value equal to fiber density (kF/inch²)×interference (mm)/fineness (denier),

the difference between the maximum torque and the minimum torque,

the ratio between the maximum torque and the minimum torque,

the minimum torque (CN—m) (=torque in Condition 1), and

the maximum torque (CN·m) (=torque in Condition 2).

In FIG. 6, “the variation width of the rotating torque is small” means that the difference between the maximum torque and the minimum torque (torque difference) is small or that the ratio between the maximum torque and the minimum torque (torque ratio) is small.

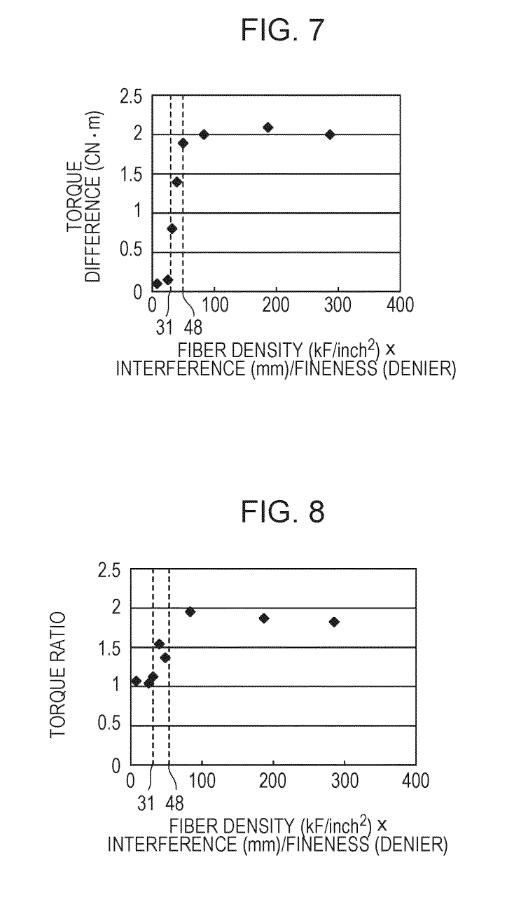

Here, on the basis of the measurement results obtained in FIG. 6, the relationship between the value equal to fiber density (kF/inch²)×interference (mm)/fineness (denier) and the torque difference is shown in the graph of FIG. 7, and the relationship between the value equal to fiber density (kF/inch²)×interference (mm)/fineness (denier) and the torque ratio is shown in the graph of FIG. 8.

As shown in these figures, it is understood that, when the value equal to fiber density (kF/inch²)×interference (mm)/fineness (denier) is less than 48, the torque difference and the torque ratio are reduced suddenly. That is, the torque variation is small. Further, it is understood that, when this value is less than 31, there is almost no torque difference, so that the torque ratio approximates to 1, that is, the torque variation is further reduced. Therefore, when such cleaning brushes are used in the image forming apparatus, the members that are cleaned are reliably cleaned.

In general, when bias voltages are applied to cleaning brushes, the load torque of a member that is driven (the second transfer transport belt 42a in the exemplary embodiment) is increased in accordance with the applied bias voltage and rotational speed. However, it is found that, when brush portions manufactured by way of trial and whose materials, finenesses, fiber densities, and interferences are changed are tested, the following is true. That is, as shown in FIGS. 6 to 8, regardless of the rotational speeds and the applied bias voltages of the cleaning brushes, it is possible to obtain cleaning brushes that allow the load torque of the member that is driven to be stabilized, that is, that suppress variations in the load torque of the member that is driven.

That is, it is ascertained that, regardless of the materials of the cleaning brushes (that is, whether or not the materials of the cleaning brushes are, for example, nylon, polyester, or acryl, which is easily processed into fibers at a low cost), it is possible to obtain cleaning brushes having considerably reduced torque variations when the finenesses (denier), the fiber densities (kF/inch²), and the interferences (mm) of the cleaning brushes are maintained in the following conditions.

That is, the conditions are:

0<fiber density (kF/inch²)×interference (mm)/fineness (denier)<48,

desirably, 0<fiber density (kF/inch²)×interference (mm)/fineness (denier)<31.

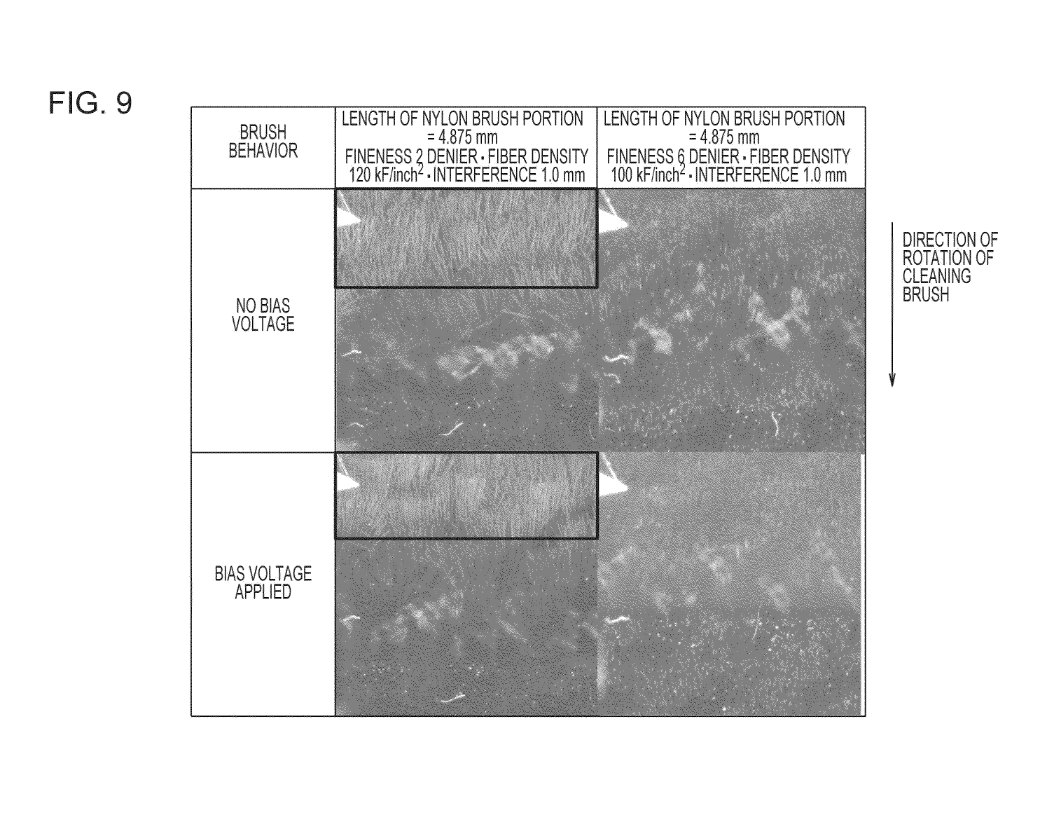

Regarding a mechanism that causes the above to occur, the behaviors of cleaning brushes are analyzed. The results of the analysis are shown in FIG. 9.

In FIG. 9, each brush portion is formed of nylon, and has a length of 4.875 mm. The two upper and low photographs on the left in FIG. 9 show the behavior of the brush portions having a fineness of 2 denier, a fiber density of 120 kF/inch², and an interference of 1.0 mm (fiber density×interference/fineness=60; torque variation is increased). The upper photograph shows the behavior when a bias voltage is not applied and the cleaning brush is rotated, whereas the lower photograph shows the behavior when a bias voltage is applied and the cleaning brush is rotated. The two upper and lower photographs on the right in FIG. 9 show the behavior of the brush portions having a fineness of 6 denier, a fiber density of 100 kF/inch², and an interference of 1.0 mm (fiber density×interference/fineness=16.7; torque variation is reduced). The upper photograph shows the behavior when a bias voltage is not applied and the cleaning brush is rotated, whereas the lower photograph shows the behavior when a bias voltage is applied and the cleaning brush is rotated.

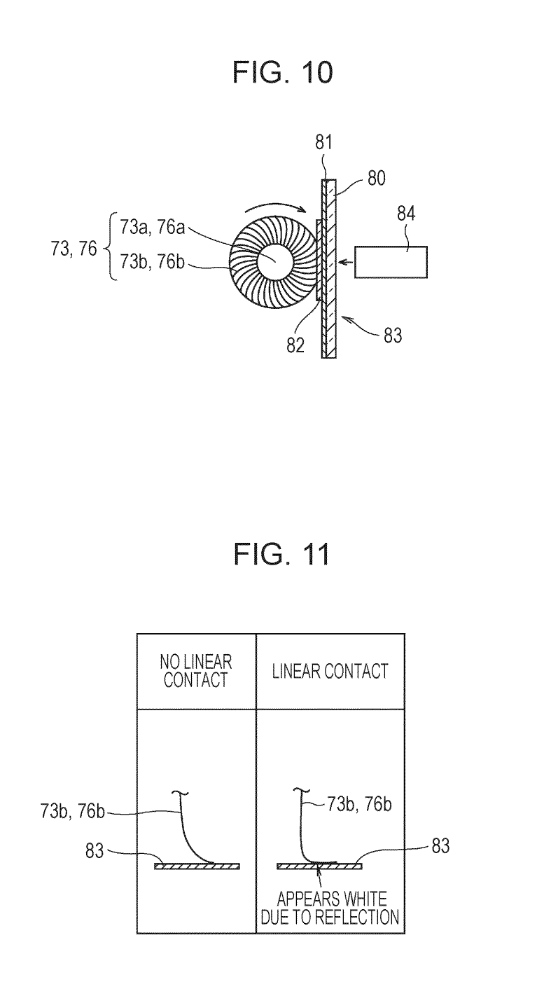

These photographs are taken by a device such as that shown in FIG. 10. That is, a thin-film layer 81 formed by evaporating a metal is formed on a transparent glass 80, and an insulating transparent tape 82 is bonded to the thin-film layer 81, so that a substrate 83 is formed. Cleaning brushes 73 and 76 are rotated so as to contact the transparent tape 82, and these are photographed with an imaging device 84, such as a charge coupled device (CCD) camera, from the opposite side.

In these photographs, as shown in FIG. 11, portions that are shining white are where ends of the brush portions 73b and 76b linearly contact the substrate 83.

In the two upper and lower photographs shown on the left in FIG. 9, when a bias voltage is not applied (upper photograph), the fibers of the brush portions are spread, whereas, when a bias voltage is applied (lower photograph), the brush portions are attracted to the substrate 83, and the fibers of the brush portions are aligned upward because the direction of rotation in FIG. 9 is downward.

As a result, the area of contact of the brush portions due to linear contact with the substrate 83 is increased (torque variation is a huge factor), a bunch of fibers of the brush portions is loosened and contacts the substrate 83 so as to fill a gap (torque variation is an intermediate factor), and an effective nip width is increased by the attraction (torque variation is a small factor), so that the torque variation is increased.

In contrast, in the two upper and lower photographs shown on the right in FIG. 9, when a bias voltage is not applied (upper photograph) and when a bias voltage is applied (lower photograph), the brush portions are not attracted to the substrate 83, so that the brush portions do not linearly contact the substrate 83.

This is believed to be because the fibers of the brush portions are strong and spreading of the bunch of fibers is small, as a result of which the torque variation is reduced.

Although the invention carried out by the inventors is described in detail on the basis of an exemplary embodiment, the exemplary embodiment disclosed in the specification is an exemplification on all points, and should not to be thought of as limiting the disclosed technology. That is, the technical scope of the present invention is not to be construed in a limited sense on the basis of the explanation in the exemplary embodiment. The technical scope of the present invention should be strictly construed in accordance with the scope of the claims. Accordingly, technologies that are equivalent to the technology that is set forth in the scope of the claims and all modifications that do not depart from the gist of the scope of the claims are included.

For example, although, in the exemplary embodiment, two cleaning devices C1 and C2 are used, only one of the cleaning devices that apply a voltage having a polarity opposite to that of the toner may be used.

The brush portions 73b and 76b of the corresponding cleaning brushes 73 and 76 according to the exemplary embodiment may be formed of materials other than the aforementioned nylon, polyester, and acryl.

Further, in the exemplary embodiment, the cleaning devices C1 and C2, serving as exemplary cleaning devices, are described as cleaning the second transfer device 42 serving as a transfer unit that is an exemplary member to be cleaned. As the member to be cleaned, for example, the photoconductor drum 21 (serving as an image carrier), the intermediate transfer belt 30 (serving as an image carrier), or the first transfer roller 25 (serving as a transfer unit) may also be used.

Although, in the foregoing description, the present invention is described as being applied to a second-transfer image forming apparatus, the present invention may also be applied to a direct-transfer image forming apparatus that directly transfers to a recording medium a developer image developed on an image carrier such as a photoconductor drum.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A cleaning device comprising:
a cleaning unit including a shaft portion and a plurality of contactors, the shaft portion being rotatably provided, the contactors being provided along an outer periphery of the shaft portion so as to contact a member to be cleaned, the contactors being formed of conductive fiber, the cleaning unit cleaning the member to be cleaned by rotating and by electrostatically attracting dirt adhered to the member to be cleaned,
wherein the contactors satisfy the following condition:
0<fiber density (kF/inch²)×interference (mm) with respect to the member to be cleaned/fineness (denier)<48.

2. A cleaning device comprising:
a cleaning unit including a shaft portion and a plurality of contactors, the shaft portion being rotatably provided, the contactors being provided along an outer periphery of the shaft portion so as to contact a member to be cleaned, the contactors being formed of conductive fiber, the cleaning unit cleaning the member to be cleaned by rotating and by electrostatically attracting dirt adhered to the member to be cleaned,
wherein the contactors satisfy the following condition:
0<fiber density (kF/inch²)×interference (mm) with respect to the member to be cleaned/fineness (denier)<31.

3. The cleaning device according to claim 1, wherein each contactor is formed of polyester, acryl, or nylon.

4. The cleaning device according to claim 2, wherein each contactor is formed of polyester, acryl, or nylon.

5. An image forming apparatus comprising:
an image carrier that carries a developer image;
a transfer unit that transfers the developer image on the image carrier to a recording medium; and
the cleaning device according to claim 1 that cleans the image carrier, serving as the member to be cleaned, or the transfer unit, serving as the member to be cleaned.

6. An image forming apparatus comprising:
an image carrier that carries a developer image;
a transfer unit that transfers the developer image on the image carrier to a recording medium; and
the cleaning device according to claim 2 that cleans the image carrier, serving as the member to be cleaned, or the transfer unit, serving as the member to be cleaned.

7. An image forming apparatus comprising:
an image carrier that carries a developer image;
a transfer unit that transfers the developer image on the image carrier to a recording medium; and
the cleaning device according to claim 3 that cleans the image carrier, serving as the member to be cleaned, or the transfer unit, serving as the member to be cleaned.

8. An image forming apparatus comprising:
an image carrier that carries a developer image;
a transfer unit that transfers the developer image on the image carrier to a recording medium; and
the cleaning device according to claim 4 that cleans the image carrier, serving as the member to be cleaned, or the transfer unit, serving as the member to be cleaned.

9. The image forming apparatus according to claim 5, wherein the transfer unit serving as the member to be cleaned is formed of a conductive resin material.

10. The image forming apparatus according to claim 6, wherein the transfer unit serving as the member to be cleaned is formed of a conductive resin material.

11. The image forming apparatus according to claim 7, wherein the transfer unit serving as the member to be cleaned is formed of a conductive resin material.

12. The image forming apparatus according to claim 8, wherein the transfer unit serving as the member to be cleaned is formed of a conductive resin material.
